(19) United States
(12) Patent Application Publication
(10) Pub. No.: US 2012/0280502 A1
(43) Pub. Date: Nov. 8, 2012

(54) POWER TRANSMISSION TRAIN

(75) Inventors: Stephan Bouvier, Graz (AT); Heinz Lanzenberger, Graz (AT); Andreas Schmidhofer, Bruck an der Mur (AT)

(73) Assignee: MAGNA E-Car Systems GmbH & Co OG, Graz (AT)

(21) Appl. No.: 13/522,344

(22) PCT Filed: Dec. 20, 2010
(86) PCT No.: PCT/EP2010/070298

§ 371 Date: Jul. 16, 2012

(30) Foreign Application Priority Data
Jan. 15, 2010 (DE) 10 2010 004 709.0

(51) Int. Cl. B60L 11/12

(52) U.S. Cl. 290/45; 180/65.21; 903/903

(57) ABSTRACT

A power transmission train for a range extender module, including an internal combustion engine, an AC generator which is mechanically driven by the internal combustion engine, and a rectifier which is electrically connected to the AC generator and has a unidirectional DC/DC converter connected downstream for the purpose of feeding an electrical load, with the internal combustion engine being equipped with its own electric starter motor.

### CROSS-REFERENCE TO RELATED APPLICATIONS

The present application is a National Stage Application of PCT International Application No. PCT/EP2010/070298 (filed on Dec. 20, 2010), under 35 U.S.C. §371, which claims priority to German Patent Application No. 10 2010 004 709.0 (filed on Jan. 15, 2010). which are each hereby incorporated by reference in their respective entireties.

### FIELD OF THE INVENTION

The invention relates to a power transmission train for a range extender module.

### BACKGROUND OF THE INVENTION

Assemblies which extend the range of the vehicle beyond the purely electric range are intended to be employed in future drives for electric vehicles. To this end, so-called range extender modules which contain a small internal combustion engine which drives-a mechanically coupled generator for generating auxiliary and/or emergency power are under discussion. In this case. the internal combustion engine is operated continuously at its optimum operating point, as a result of which the development of emissions and noise can be minimized.

Known solutions for power transmission trains of this kind also use the generator in the reverse mode as a motor for starting the internal combustion engine. To this end, a bidirectional inverter module is connected downstream of the generator, said inverter module generating direct current for the vehicle battery from the generator alternating current in the generator mode and converting direct current from the vehicle battery into the corresponding alternating current for feeding the generator in the motor mode. A bidirectional inverter module of this kind is complex and correspondingly costly. In addition, the generator and the inverter module have to be designed for the high starting torque of the internal combustion engine and therefore a correspondingly high starting current. This means a large installation space and a high weight, this being impractical particularly for relatively small electric vehicles for reasons of cost and space. In addition, by way of example, a synchronous generator, when it is used as a motor, requires an angular position sensor for operation, this presenting a further disadvantage in respect of cost.

### SUMMARY OF THE INVENTION

An objective of the invention is to create a power transmission train for a range extender module which is more cost-effective, more lightweight and more space-saving than the known designs, in particular in order to allow it to be used in small city vehicles.

In accordance with the invention, this objective is achieved by way of a power transmission train which is distinguished by the sequence comprising an internal combustion engine, an AC generator which is mechanically driven by said internal combustion engine, and a rectifier which is electrically connected to said AC generator and has a unidirectional DC/DC converter connected downstream for the purpose of feeding an electrical load, with the internal combustion engine being equipped with its own electric starter motor.

The invention is based on the surprising finding that considerable costs, weight and installation space can be saved when the power transmission train is designed exclusively in a unidirectional manner, that is to say comprising the unidirectional sequence of starter motor→internal combustion engine→AC generator→rectifier→DC/DC converter, even if it requires a dedicated starter motor: a costly bidirectional inverter can be dispensed with. Since the inverter and generator do not have to be dimensioned for the high starting current of an internal combustion engine, considerable installation space and weight can be saved. In addition, a simple passive rectifier is sufficient, and the separate starter motor for the internal combustion engine is a commercially available, cost-effective part. Furthermore, the angular position sensor in the generator is also dispensed with, this saving further costs.

It is particularly advantageous when, In accordance with a preferred embodiment of the invention, the starter motor is a commercially available standard 12-volt starter motor.

The AC generator is preferably a three-phase permanent-magnet synchronous machine (PSM) which is distinguished. by a particularly simple and robust design.

For the same reason, it is particularly expedient when the rectifier is a three-phase passive full-wave rectifier, preferably a diode bridge.

On account of the uni-directionality of the power transmission train, a very simple DC/DC converter can be used, as is preferably formed by a microprocessor-controlled charge pump.

It is particularly advantageous when the load is a high-voltage battery for an electric traction drive, for which high-voltage battery the DC/DC converter can provide the corresponding voltage level in a microprocessor-controlled manner.

A further advantageous embodiment of the invention is distinguished in that the internal combustion engine and/or the AC generator have/has a liquid cooling system which also cools the rectifier and/or the DC/DC converter. As a result, further components and therefore installation space, weight and costs can be saved.

It is particularly advantageous when the rectifier and the DC/DC converter are integrated in the housing of the AC generator or are flange-connected to said housing of the AC generator in order to create an autonomous unit.

The power transmission train is preferably in the form of an exchangeable range extender module for a hybrid vehicle in which it can be inserted in a modularly exchangeable manner, for example.

### BRIEF DESCRIPTION OF THE DRAWINGS

The invention will be explained in greater detail below with reference to an exemplary embodiment which is illustrated in the appended drawing, in which:

FIG. 1 illustrates a block circuit diagram of the power transmission train in accordance with the invention.

### DETAILED DESCRIPTION OF EMBODIMENTS

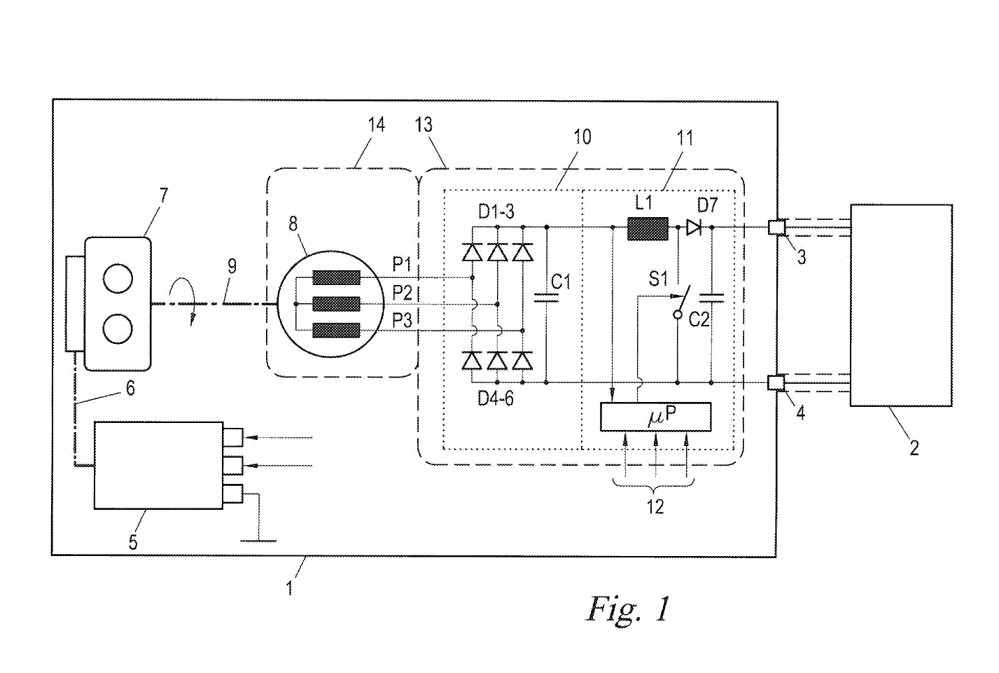

FIG. 1 illustrates a range extender module 1 which feeds a high-voltage battery 2 for an electric traction drive (not shown further) of a hybrid vehicle. The range extender module 1 is, as an autonomous, modularly exchangeable unit, arranged, for example, in a housing or on an assembly support and is equipped with electrical connections 3, 4 for connection to the high-voltage battery 2.

The range extender module 1 contains a unidirectional power transmission train which includes, in succession, the following.

A starter motor 5, as is commercially available, for example, as a standard 12-volt starter motor for motor vehicles. A low- to medium-power internal combustion engine 7 which can be started by the starter motor 5 by means of, for example, a belt drive or a pinion 6, for example, in the range of 15 to 30 kW. The internal combustion engine 7 is preferably controlled by a control device (not illustrated) which can communicate with the rest of the vehicle via a suitable bus system, for example, in accordance with the HS-CAN or FlexRay standard.

An AC generator 8, preferably in the form of a three-phase permanent-magnet synchronous machine (PSM), which generator 8 is driven by the internal combustion engine 7 via a shaft 9, a gear drive, belt drive or the like.

A rectifier 10 which is electrically connected to the generator 8, preferably a simple passive three-phase full-wave rectifier in the form of a diode bridge comprising a plurality, for example six, fast diodes D1-D6 and a smoothing capacitor C1.

A DC/DC converter 11, which is connected downstream of the rectifier 10, for smoothing and upward or downward transformation of the output voltage of the rectifier 10 to the desired potential across the connections 3, 4. The DC/DC converter 11 is, in the illustrated preferred embodiment, a microprocessor-controlled charge pump with a storage inductor L1, a storage capacitor C2 and a charging circuit comprising a diode D7 and a switch S1 which is controlled by a microprocessor μP.

The microprocessor μP operates the switch S1, and therefore, the DC/DC converter 11 with a high internal clock frequency. Accordingly, the size of the components can be kept small. The timing ratio and duty ratio of the switch S1 can be used to set the voltage, and therefore, also the transmitted power. In this case, the microprocessor μP also performs communication with vehicle components via a bus 12, for example, in accordance with the HS-CAN or FlexRay standard, in order to release the desired power.

The power which is to be generated or the desired charging current for the high-voltage battery 2, for example, is prespecified as the control variable. The control system can, for example, acquire data from a current sensor in the output connections 3, 4, a voltage sensor at the input and/or output of the DC/DC converter 11 and from internal temperature sensors. Special charging characteristic curves for the high-voltage battery 2 can be realized by software and he controlled by means of the microprocessor μP.

As a result of additional protective measures in the DC/DC converter 11, for example, a turn-off transistor, overvoltages which occur across the generator 8 in the event of a fault, for example in the case of an excessive rotation speed, can be decoupled from the connections 3, 4 and therefore undesired charging or increases in voltage at the electrical load can be prevented.

The rectifier 10 and/or the DC/DC converter 11 are preferably liquid-cooled, specifically particularly preferably by the same liquid cooling system, which also cools the generator 8 and/or the internal combustion engine 7. The rectifier 10 and the DC/DC converter 11 can preferably be integrated in a common housing 13 and, particularly preferably, also with the or in the housing 14 of the generator 8.

The field of use of the power transmission train 5-11 is not restricted to the illustrated application of charging a high-voltage battery 2 or feeding an electric traction drive, but rather can also comprise stationary applications, for example in auxiliary or emergency power assemblies.

Accordingly, the invention is not restricted to the illustrated embodiments, but rather comprises all variants and modifications which fall. within the scope of the connected claims.

Although embodiments have been described herein, it should he understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1-10. (canceled)

11. A power transmission train for a range extender module, the power transmission train comprising:
an internal combustion engine having an electrical starter motor;
a three-phase permanent-magnet synchronous machine mechanically driven by the internal combustion engine;
a three-phase passive full-wave rectifier electrically connected to the three-phase permanent-magnet synchronous machine;
a first liquid cooling system configured to cool the internal combustion engine and the three-phase passive full-wave rectifier;
a second liquid cooling system configured to cool the three-phase permanent-magnet synchronous machine and the three-phase passive full-wave rectifier; and
a microprocessor-controlled charge pump connected downstream of the three-phase passive full-wave rectifier and configured to feed a high-voltage battery of an electric traction drive.

12. An apparatus comprising:
an internal combustion engine having a motor;
an AC generator mechanically driven by the internal combustion engine;
a rectifier electrically connected to the AC generator;
a unidirectional DC/DC converter connected downstream of the rectifier and configured to feed an electrical load;
a first liquid cooling system configured to cool the internal combustion engine and the unidirectional DC/DC converter; and
a second liquid cooling system configured to cool the AC generator and the unidirectional DC/DC converter.

13. The apparatus of claim 12, wherein the motor comprises an electric starter motor.

14. The apparatus of claim 13, wherein the electric starter motor comprises a 12-volt electric starter motor.

15. The apparatus of claim 12, wherein the AC generator comprises a three-phase permanent-magnet synchronous machine.

16. The apparatus of claim 12, wherein the rectifier comprises a three-phase passive full-wave rectifier.

17. The apparatus of claim 12, wherein the unidirectional DC/DC converter comprises a microprocessor-controlled charge pump.

18. The apparatus of claim 12, wherein the electrical load comprises a high-voltage battery of an electric traction drive.

19. The apparatus of claim 12, wherein the rectifier and the DC/DC converter are integrated in a housing of the AC generator.

20. The apparatus of claim 12, wherein the rectifier and the DC/DC converter are connected to a housing of the AC generator.

21. The apparatus of claim 12, wherein the apparatus comprises a power transmission train for a range extender module.

22. The apparatus of claim 21, wherein the range extender module. comprises an exchangeable range extender module for a hybrid vehicle.

23. An apparatus comprising:
an internal combustion engine having a motor;
an AC generator mechanically driven by the internal combustion engine;
a rectifier electrically connected to the AC generator; and
a DC/DC converter configured to feed an electrical load.

24. The apparatus of claim 23, wherein:
the motor comprises an electric starter motor;
the AC generator comprises a three-phase permanent-magnet synchronous machine;
the rectifier a diode bridge;
the DC/DC converter comprises a microprocessor-controlled charge pump; and
the electrical load comprises a high-voltage battery of an electric traction drive.

25. The apparatus of claim 23, wherein the internal combustion engine has a cooling system configured to cool the internal combustion engine.

26. The apparatus of claim 25, wherein the cooling system comprises a liquid cooling system which is configured to also cool one of the rectifier and the DC/DC converter.

27. The apparatus of claim 23, wherein the AC generator has a cooling system.

28. The apparatus of claim 27, wherein the cooling system comprises a liquid cooling system which is configured to also cool one of the rectifier and the DC/DC converter.

29. The apparatus of claim 23, wherein the apparatus comprises a power transmission train for a range extender module.

30. The apparatus of claim 23, wherein the range extender module. comprises an exchangeable range extender module for a hybrid vehicle.
